(19) United States
(12) Patent Application Publication
(10) Pub. No.: US 2014/0127479 A1
(43) Pub. Date: May 8, 2014

(54) ADHESIVELY BONDED TISSUE LAMINATES

(71) Applicant: Kimberly-Clark Worldwide, Inc., Neenah, WI (US)

(72) Inventors: Mark Alan Zietlow, Appleton, WI (US); Thomas Garrett Neal, JR., Appleton, WI (US); Jay Christopher Olszewski, Menasha, WI (US); Christopher Lee Satori, Hortonville, WI (US); Gary Lee Shanklin, Fremont, WI (US)

(73) Assignee: Kimberly-Clark Worldwide, Inc., Neenah, WI (US)

(21) Appl. No.: 14/047,203

(22) Filed: Oct. 7, 2013

Related U.S. Application Data
(60) Provisional application No. 61/723,404, filed on Nov. 7, 2012.

(51) Int. Cl. B32B 7/04

(52) U.S. Cl. CPC B32B 7/045
USPC 428/201

(57) ABSTRACT

The present disclosure provides a multi-ply tissue product, also referred to herein as a tissue laminate, wherein the plies are adhesively adjoined by the zoned application of an adhesive. The zoned application of adhesive results in plies being adhesively joined by two or more longitudinally oriented strips of adhesive adjacent to the lateral edges of the ply. The resulting adhesively joined tissue has relatively high degrees of ply attachment, yet has relatively low stiffness.

### BACKGROUND

Consumer tissue products such as facial tissue and bath tissue are generally used to absorb body fluids and leave the skin dry. The tissues are predominantly formed of cellulosic paper-making fibers by manufacturing techniques designed specifically to impart softness to the tissue. Despite specific efforts to select fibers and form the tissues with high levels of softness, these consumer tissue products may still have a tendency to abrade the skin.

In an attempt to reduce skin abrasion, additive compositions have been applied to the tissue. The additive compositions, sometimes generally referred to as lotions, function either to provide lubricity causing the tissue to glide across the surface of the skin, or to leave the tissue and be deposited on the skin for a skin health/cosmetic benefit. Additive compositions have been applied to tissues by techniques such as printing or spraying and at levels typically above 1 weight percent to as much as 30 weight percent, based on the weight of the tissue.

In the past, however, various problems have been experienced in constructing tissue products with lotions. For instance, lotions tend to cause multi-ply tissues to de-ply. It is theorized that ply bonding is impaired because these formulations contain oily, waxy, or both oily and waxy components which hinder bonding between the plies. It appears that the lotion may actually interrupt fiber-to-fiber bonding between the plies. Moreover, it is theorized that conventional mechanical ply bonding processes such as embossing and crimping are inherently ineffective for ply bonding of lotion treated tissues. Modern, uncoated tissue products also suffer from poor ply attachment due to product design such as low moisture creping and/or, high performance process additives resulting in dust and fiber deposition in crimping wheels, which reduces the clarity of the crimper wheel pattern.

A variety of approaches have been employed over the years in an attempt to improve the ply bonding of lotion treated tissues. One approach has been to apply the lotion formulation after the tissue has been ply bonded. While this approach partially improves ply bonding, it continues to have inherent deficiencies because the mechanical forces associated with applying lotion to the tissue may disrupt the previously imparted bonds. Also, it is theorized that the oily and waxy components of the lotion may diminish fiber-to-fiber bonds even when the lotion is applied after the ply bonding operation.

Another approach to the problem is suggested in U.S. Pat. No. 4,513,051, which discloses a method of treating a multi-ply tissue product with an emollient, where the emollient is distributed over a major portion of each surface except for the area in which the plies are crimped together. An apparent disadvantage with this approach is that a portion of the planar surface area of the tissue is void of the additive composition.

Consequently, a need still remains to improve ply bonding, as well as a process to provide enhanced ply bonding of both treated and non-treated multi-ply tissues.

### SUMMARY

It has now been discovered that a multi-ply tissue laminate having good inter-ply attachment and low stiffness may be produced by adhesively bonding plies together by the zoned application of adhesive. Even tissue plies that have been post-treated with lotions or silicones, or those having very fine crepe structure, are amenable to attachment by the zoned application of adhesive. In this manner, the zoned application of adhesive yields an adhesively bonded tissue laminate having a ply attachment strength of at least about 15 grams. The ply attachment achieved by adhesive bonding is comparable, and in some instances superior to, ply attachment strength achieved by mechanical crimping.

Accordingly, in one aspect the present disclosure provides an adhesively bonded multi-ply tissue laminate comprising a first tissue ply, a second tissue ply and an adhesive disposed between the first and second plies, wherein adhesive is disposed to provide at least two discrete continuous bonded areas that extend the length of the plies.

In other aspects the present disclosure provides an adhesively bonded multi-ply tissue laminate having first and second edges, the laminate comprising a first tissue ply, a second tissue ply and at least two longitudinally orientated strips of adhesive disposed between the first and second plies and adjacent to the first and second edges.

In yet other aspects the present disclosure provides an adhesively bonded multi-ply tissue laminate comprising a first unembossed tissue ply, a second unembossed tissue ply and two discrete longitudinally orientated continuous strips of adhesive disposed between the first and second plies, wherein the tissue laminate has a ply attachment strength of at least about 15 grams, a Stiffness Index less than about 20 and a geometric mean tensile of at least about 500 g/3″.

In still other aspects the present disclosure provides an adhesively bonded multi-ply tissue laminate comprising a first unembossed tissue ply, a second unembossed tissue ply and two discrete longitudinally orientated continuous strips of adhesive disposed between the first and second plies, wherein the tissue laminate has a ply attachment strength from about 15 to about 35 grams, a Stiffness Index from about 10 to about 15 and a geometric mean tensile from about 700 to about 900 g/3″.

Other features and aspects of the present disclosure are discussed in greater detail below.

### DESCRIPTION OF THE DRAWINGS

FIG. 1 illustrates one embodiment of a tissue laminate, shown partially in cutaway, according to the present disclosure;

FIG. 2 is a sectional view taken through line 2-2 of FIG. 1.

FIG. 3 is a process overview illustrating one embodiment for manufacturing an adhesively bonded tissue product according to the present disclosure; and

FIG. 4 is a process overview illustrating another embodiment for manufacturing an adhesively bonded tissue product according to the present disclosure.

### DEFINITIONS

As used herein, the term “tissue product” refers to products made from tissue webs and includes, bath tissues, facial tissues, paper towels, industrial wipers, foodservice wipers, napkins, medical pads, and other similar products.

As used herein, the terms “tissue web” and “tissue sheet” refer to a fibrous sheet material suitable for use as a tissue product.

As used herein, the term “ply attachment strength” refers to the peak force, typically having units of grams (g), necessary to separate two plies of a tissue laminate. Ply attachment strength is measured as described in the Test Method section.

As used herein, the term “geometric mean tensile” (GMT) refers to the square root of the product of the machine direction tensile and the cross-machine direction tensile of the web, which are determined as described in the Test Method section.

As used herein, the term “slope” refers to slope of the line resulting from plotting tensile versus stretch and is an output of the MTS TestWorks™ in the course of determining the tensile strength as described in the Test Methods section. Slope is reported in the units of kilograms force (kgf) per unit of sample width (inches) and is measured as the gradient of the least-squares line fitted to the load-corrected strain points falling between a specimen-generated force of 70 to 157 grams (0.687 to 1.540 N).

As used herein, the term “geometric mean slope” (GM Slope) generally refers to the square root of the product of machine direction slope and cross-machine direction slope.

As used herein, the term “Stiffness Index” refers to quotient of the geometric mean slope (expressed in units of kgf/3″) divided by the geometric mean tensile strength (expressed in units of g/3″) multiplied by 1,000 as set forth below:

$$Stiffness Index = \frac{\sqrt{MD Slope \times CD Slope}}{GMT} \times 1 \text{,} 000$$

The Stiffness Index is expressed herein without units.

### DETAILED DESCRIPTION

The present disclosure provides a multi-ply tissue product (also referred to herein as a tissue laminate or laminate) wherein the plies (also referred to herein as lamina) are adhesively adjoined by the zoned application of an adhesive. More preferably the plies are adhesively joined by two or more longitudinally oriented strips of adhesive. In a particularly preferred embodiment the plies are joined by two discrete continuous longitudinally oriented strips of adhesive that are disposed immediately adjacent to the lateral edges of one of the plies.

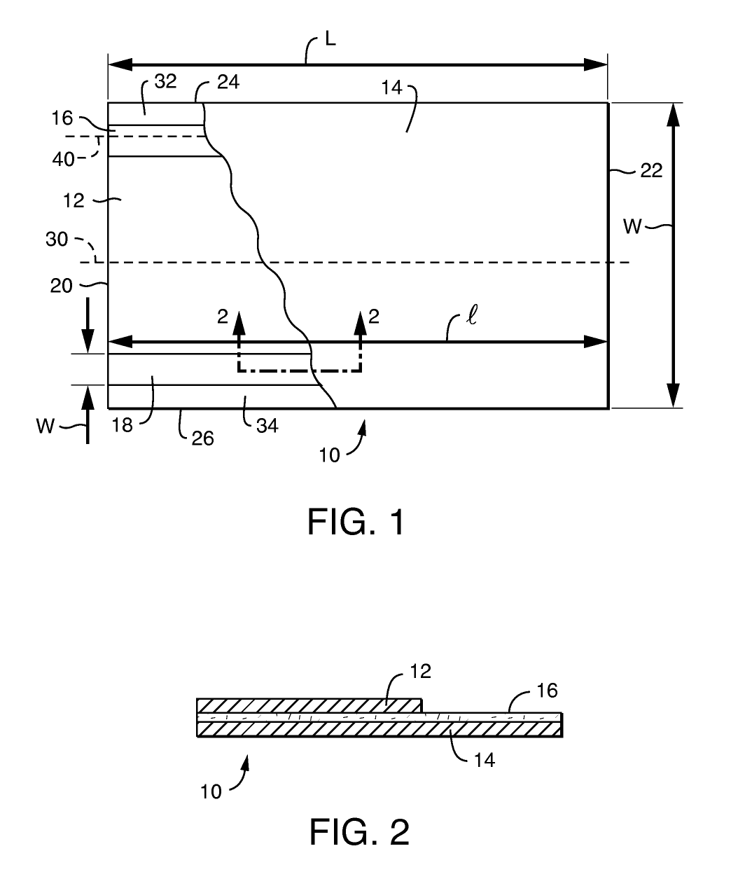

With reference to FIG. 1, the tissue product is a two-dimensional laminate 10 formed from a first 12 and a second 14 tissue ply. More particularly, the two plies 12 and 14 are joined in face-to-face relation to form the laminate 10. The two plies 12 and 14 are joined by two strips of adhesive 16 and 18, which are interposed between the plies 12 and 14 and contact the inwardly oriented face of each ply 12 and 14. The adhesive strips 16, 18 may be applied to the inwardly oriented face of either ply 12 or 14, or in other embodiments, to the inwardly oriented face of both plies 12 and 14.

The plies are joined by the adhesive such that the ply attachment strength is at least about 15 grams, more preferably at least about 25 g, and still more preferably at least about 40 g, such as from about 15 to about 100 g. In this manner the tissue laminates have ply attachment strength comparable or greater than mechanically crimped tissue products.

While FIG. 1 illustrates the laminate 10 as being formed from two plies 12, 14, it is to be understood that the present disclosure is not limited to tissue products comprising only two plies. Multi-ply tissue products prepared as described herein preferably comprise two or more plies, such as two, three or four plies.

The plies are preferably fibrous sheet material. In a particularly preferred embodiment the plies comprise a cellulosic fibrous material, such as wood pulp, cotton linters, or the like. However in other embodiments the plies may comprise synthetic fibers, such as polyolefin or polyester fibers. In still other embodiments the plies may comprise a mixture of cellulosic and synthetic fibers. The plies may consist substantially of the same fibrous material, or they may be different. For example, in one embodiment all of the plies comprise wood pulp fibers. In another embodiment one ply comprises synthetic fibers and another ply comprises wood pulp fibers.

The tissue product 10 (including both plies 12, 14 and the adhesive 16) preferably has a basis weight greater than about 20 grams per square meter (gsm), such as from about 20 to about 60 gsm, more preferably from about 25 to about 60 gsm and still more preferably from about 30 to about 60 gsm.

The tissue plies and the tissue product formed therefrom generally have first and second ends 20, 22 and first and second edges 24, 26. The plies are generally rectangular and in certain embodiments may be square, i.e., the length dimension of the first and second ends 20, 22 and the first and second edges are equal 24, 26. In a particularly preferred embodiment the tissue plies are rectangular and more preferably have first and second ends 20, 22 with a width dimension (W) that is greater than the length (L) of the first and second edges 24, 26. In a particularly preferred embodiment W is at least about 2 percent greater than L and more preferably at least about 5 percent greater than L.

Regardless of the dimensions of the tissue 10, it is preferred that the adhesive strip 16 be orientated longitudinally. As used herein, a strip is considered oriented “longitudinally” if the principal direction of the strip is substantially parallel to the machine direction of the tissue product 10 during manufacture. For purposes of comparison, the perforations of toilet tissue and paper toweling are generally transversely oriented and occur at right angles to the longitudinal direction. In a particularly preferred embodiment the adhesive 16 is oriented substantially parallel to the first and second edges 24, 26 (and also to the longitudinally oriented midpoint of the laminate 30) and perpendicular to the first and second ends 20, 22.

While it is preferred that the adhesive strip 16 be oriented longitudinally, the strip itself may comprise any desired geometry and may be either continuous or discontinuous. As used herein “continuous” refers to a strip of adhesive disposed in an uninterrupted pattern. A strip may be considered continuous even in those instances where the strip is applied using a method, such as spraying, that results in the adhesive being deposited as individual dots or droplets, so long as the adhesive is applied in an uninterrupted pattern. In those instances where the adhesive is continuous and applied by spraying preferably nozzles are selected so that the sprayed product takes the form of a continuous stream of adhesive.

In other embodiments the adhesive strip is discontinuous such that the adhesive is not applied in an uninterrupted pattern. Rather, in such embodiments discrete areas of tissue that are substantially free of adhesive are interposed between adhesive areas. Discontinuous strips of adhesive may be applied by such means as pulsed spraying, slotted coating or printing of the adhesive.

A longitudinally oriented continuous adhesive pattern is particularly preferred. In such preferred embodiments, such as the embodiment illustrated in FIG. 1, the adhesive strip 16 has a length (l) and width (w). In a particularly preferred embodiment the lengths 1 and L of adhesive strip 16 are equal and w is at least about 0.5 centimeters, still more preferably at least about 1.0 centimeters and still more preferably at least about 2.0 centimeters, such as from about 0.5 to about 2.5 centimeters.

Further, it is preferred that the laminate comprise two or more discrete strips. As illustrated in FIG. 1, in a preferred embodiment the laminate 10 comprises two strips 16 and 18 which are spaced apart from one-another and adjacent to the first and second edges 24, 26. In other embodiments the adhesive may be disposed as three, four, five or six, discrete strips. However, it is to be understood that to avoid stiffening the laminate and to minimize manufacturing costs, the minimum number of adhesive strips necessary to achieve satisfactory ply attachment is desirable.

To further minimize manufacturing costs and avoid unnecessarily stiffening the tissue product a minimal amount of adhesive is applied. Preferably the amount of adhesive applied is sufficient to achieve a ply attachment strength of at least about 15 grams. Accordingly, in one preferred embodiment the tissue laminate 10 comprises less than about 200 milligrams of adhesive per square meter of treated area, and more preferably less than about 100 mg/m², such as from about 20 to about 200 mg/m². The amount of adhesive is measured as the total mass (measured in mg) of all adhesive strips applied to the tissue product divided by the total area of the strips (measured in square meters).

Controlling the size and number of adhesive strips and the amount of adhesive applied to the tissue results in a tissue product having sufficient ply attachment, such as greater than about 15 grams, without excessive stiffness. Accordingly, it is preferred that the tissue laminate have a Stiffness Index less than about 20, more preferably less than about 18, and still more preferably less than about 16, such as from about 12 to about 20. In a particularly preferred embodiment the tissue product comprises two plies attached to one another by two strips of adhesive wherein the tissue product has a ply attachment strength of at least about 15 grams, a Stiffness Index less than about 20 and a GMT of at least about 500 g/3″ and more preferably at least about 700 g/3″, such as from about 700 to about 900 g/3″.

In addition to controlling the amount of adhesive applied and the size and number of adhesive strips, stiffness may be reduced by selectively applying the adhesive strips away from the centerline 30 of the tissue product 10 and towards the lateral edges 24, 26. Accordingly, in a preferred embodiment the adhesive strips 16, 18 are applied immediately adjacent to the first and second edges 24, 26. In other embodiments the adhesive strips 16, 18 are positioned slightly inward of the first and second edges 24, 26, i.e., towards the centerline 30 of the tissue, such that there are portions of the tissue 32, 34 immediately adjacent to the edges 24, 26 that are substantially free of adhesive. If a continuous longitudinally oriented pattern is selected, preferably the centerline of the strip 40 is within about 2 centimeters of the edge 24 of the ply 12 and the adhesive free area 32 measures between about 0.5 and about 12 millimeters in width. More preferably, as illustrated in FIG. 1, the first and second adhesives strips 16, 18 are spaced equidistance from the first and second edges 24, 26 respectively.

Further, it is preferred that the adhesive strip 16 is only applied in one orientation, that is to say that where the adhesive strip 16 is applied along the length (L) of the ply 12 in a longitudinally oriented continuous pattern, no adhesive is applied along width (W) of the ply 12 parallel to the ends 20, 22. Where the laminate is rectangular (having a length (L) greater than width (W)) it is particularly preferred that the adhesive strips be longitudinally orientated and that no adhesive be applied in the transverse orientation (i.e., parallel to the laminate ends).

In this manner the tissue laminate 10 preferably comprises a first and a second ply 12, 14 and a first and a second adhesives strip 16, 18 disposed there-between, where the total tissue surface area covered by the strips is less than about 25, more preferably less than about 20 percent and still more preferably less than about 15 percent, such as from about 5 to about 15 percent. By limiting the area of tissue covered by adhesive the stiffness of the tissue product is not increased and the amount of adhesive applied is conserved, yet ply attachment is not compromised.

The adhesive 16 used in the present invention is preferably an aqueous mixture of water dispersible, and more preferably water soluble, adhesive components such as carboxymethyl cellulose, polyvinyl alcohol, starch, or the like. The adhesive is interposed between the plies 12 and 14, as illustrated in FIG. 2, by spraying or other application methods known in the art. The adhesive 16 is preferably a pressure sensitive adhesive so that adhesion occurs when the two plies 12 and 14 are brought into facing contact with one another. Preferably the adhesive is of a quick drying manner to minimize build up on other process elements.

The adhesive may be applied to the lamina using any application method known in the industry such as, for example, spraying, printing, extrusion, brushing, by means of permeable or impermeable rolls and/or pads. Particularly preferred are spray applications and more preferably air atomized spray applications. In a particularly preferred embodiment adhesive is applied to the lamina by spraying an adhesive onto one of the moving lamina from at least one nozzle array.

The adhesive 16 may be applied to only one face of either the first or second ply 12, 14. In other embodiments the adhesive 16 is applied to the inwardly oriented face of both plies 12 and 14. The plies 12 and 14 may then be combined together so that adhesive 16 bonding occurs. In one embodiment the adhesive 16 is applied to the exposed and inwardly oriented face of one of the tissue lamina 12 or 14 by moving the lamina 12 or 14 to be adhesive 16 coated past a spray nozzle from which the adhesive 16 is sprayed. In a particularly preferred embodiment the tissue lamina is moved past the application nozzle as adhesive is continuously applied to the lamina.

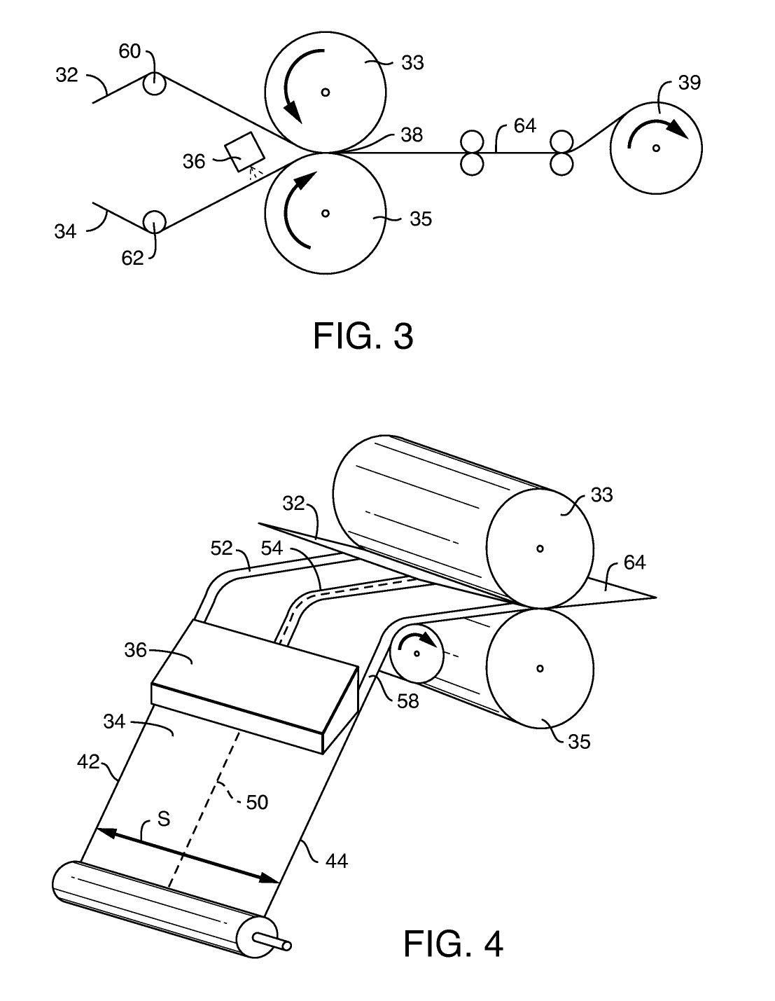

As illustrated in FIG. 3, in the manufacture of a multi-ply tissue product 64 typically each tissue lamina 32, 34 is unwound over its own carrier roll 60, 62, and a spray nozzle(s) 36 is positioned between the carrier rolls 32, 34, particularly adjacent to and downstream of the carrier rolls. In other embodiments, where the tissue product comprises more than two plies, such as three or four plies, the method of manufacture uses at least two spray nozzle arrays, a rear array to spray the bottom of an upper ply and a forward array to spray the bottom of an intermediate ply. The multiple webs 32, 34 are combined by passing through a nip 38 formed by a pair of opposed rolls 33, 35. The combined webs 32, 34 form a tissue product 64, which is wound under tension onto a roll 39. Preferably, each ply is traveling at speeds greater than about 200 meters per minute (m/min), preferably greater than about 400 m/min and more preferably greater than about 600 m/min. Preferably the dwell time for adhesive, the period from the application of the adhesive to the ply until the adhesive treated ply reaches the nip, is between about 0.25 and about 1.5 seconds. Preferably the dwell time is sufficient to partially set the adhesive such that it will contact bond when passed through the nip, but it will not migrate so far through the tissue web that it causes through bonding as the tissue laminate is wound.

Preferably, after application of the adhesive the lamina are joined by bringing them into facing relation with one another to form the laminate. In a particularly preferred embodiment a laminate is formed by passing the adhesively treated lamina over a high wrap roll to force the lamina together. In this manner strong ply adhesion can be achieved with lower adhesive loading and minimized sheet compression. In an alternate embodiment an adhesively bonded multi-ply tissue product is prepared by compressing the webs together as they run through a nip formed by two nip rolls positioned at a compression point downstream of the spray location. In this aspect of the invention, it is practical to use a pressurized nip to force the adhesively bonded webs together. The distance between the spray location and the nip is selected to permit sprayed adhesive to partially but not completely set during travel over that distance at operating web speeds. The webs may be forced together with a high wrap roll or with nip rollers that have enough pressure to substantially confine winder tension to the nip-to-winder portion of the web path, as opposed to transmitting winder tension upstream to the parent reels (i.e. the reels on which the tissue stock has been supplied to the bonder), thereby providing improved control over winder tension. Because the spray location is carefully controlled, it is possible to use such a nip without unacceptable adhesive build-up on the nip rolls.

It is preferred that after formation of the laminate, the tissue product is not subjected to any additional treatment to enhance or improve ply attachment, such as heat, mechanical crimping or embossing. Accordingly, in a particularly preferred embodiment the tissue product comprises two unembossed plies attached to one another by two strips of adhesive wherein the tissue product has a ply attachment strength of at least about 15 grams, such as from about 15 to about 20 grams, a Stiffness Index less than about 20, such as from about 15 to about 20, and a geometric mean tensile of at least about 500 g/3″, such as from about 700 to about 900 g/3″.

In an alternate embodiment, illustrated in FIG. 4, a tissue product 64 is formed by combining a first web 32 and a second web 34 at a nip 38 after a spraying apparatus 36 has applied adhesive to the second web 34. As illustrated in FIG. 4, the adhesive strips 52, 54, 58 are applied by a header 36 having three spray nozzles which spray adhesive unto the second web 34 from above. The adhesive strips 52, 54, 58 are applied along each of the first 42 and second 44 edges of the web and along its midpoint 50. When the web is slit along its midpoint 50 during converting to form two tissue products, each resulting product has an adhesive strip disposed along its first and second edges. In this manner, a tissue product having two continuous strips of adhesive immediately adjacent each of its lateral edges is formed. Preferably the tissue product has a ply attachment strength of at least about 15 grams, and more preferably at least about 20 grams and still more preferably at least about 30 grams, while having a Stiffness Index less than about 20 and more preferably less than about 15.

### Test Methods

Ply Attachment Strength

The ply attachment strength is measured using Standard Test Method (STM) 00317 Crimp Strength test for ply attachment. The test method measures the Kinetic peak force it takes to separate two bonded plies from one another. Test specimens were conditioned under TAPPI conditions for no less than 4 hours and cut to a size 4 inches by 4 inches+/−0.25 inches. The test apparatus, IMASS Models SP-200 and SP2100 Slip/Peel test runs for 5.1 seconds. Each ply is clamped into a Clip and a hold down device of the test apparatus and the Kinetic Peak (i.e., peak load) needed to completely separate the laminate is measured. The plies of the laminate are manually separated for a distance of about 2 inches along the length of the specimen. Samples having more than two plies are tested by placing one outer ply in the specimen clip and the other plies in the hold down device. The plies are pulled apart at a 180 degree angle. The test equipment platen travel rate is set at 28.0 inches per minute. The results of testing are reported as the Kinetic Peak to the nearest 0.1 gram (g).

### Basis Weight

The basis weight was measured as bone dry basis weight. Basis weight of the tissue sheet specimens may be determined using the TAPPI T410 procedure or a modified equivalent such as: Tissue samples are conditioned at 23±1° C. and 50±2 percent relative humidity for a minimum of 4 hours. After conditioning a stack of 16-3 inch by 3 inch samples is cut using a die press and associated die. This represents a tissue sheet sample area of 144 in² or 929 cm². Examples of suitable die presses are TMI DGD die press manufactured by Testing Machines, Inc., Islandia, N.Y., or a Swing Beam testing machine manufactured by USM Corporation, Wilmington, Mass. Die size tolerances are ±0.008 inches in both directions. The specimen stack is then weighed to the nearest 0.001 gram on a tared analytical balance. The basis weight in grams per square meter is calculated using the following equation: Basis weight=stack wt. in grams/0.0929.

### Tensile

Samples for tensile strength testing are prepared by cutting a 3 inches (76.2 mm) by 5 inches (127 mm) long strip in either the machine direction (MD) or cross-machine direction (CD) orientation using a JDC Precision Sample Cutter (Thwing-Albert Instrument Company, Philadelphia, Pa., Model No. JDC 3-10, Ser. No. 37333). The instrument used for measuring tensile strengths is an MTS Systems Sintech 11S, Serial No. 6233. The data acquisition software is MTS TestWorks™ for Windows Ver. 4 (MTS Systems Corp., Research Triangle Park, N.C.). The load cell is selected from either a 50 Newton or 100 Newton maximum, depending on the strength of the sample being tested, such that the majority of peak load values fall between 10 and 90 percent of the load cell's full scale value. The gauge length between jaws is 4±0.04 inches. The jaws are operated using pneumatic-action and are rubber coated. The minimum grip face width is 3 inches, and the approximate height of a jaw is 0.5 inches. The crosshead speed is 10±0.4 inches/min, and the break sensitivity is set at 65 percent. The sample is placed in the jaws of the instrument, centered both vertically and horizontally. The test is then started and ends when the specimen breaks. The peak load is recorded as either the “MD tensile strength” or the “CD tensile strength” of the specimen depending on the sample being tested. At least six (6) representative specimens are tested for each product, taken “as is,” and the arithmetic average of all individual specimen tests is either the MD or CD tensile strength for the product.

### EXAMPLES

Examples were prepared generally in accordance with the process described above. A first ply (also referred to herein as a web) of a fibrous cellulosic tissue was unwound from a supply roll. A second ply of fibrous cellulosic tissue was unwound from a second supply roll. Each ply had a basis weight of about fourteen (14) grams per square meter and a width of about sixteen (16) inches. The webs were unwound at speeds (measured as feet per minute, fpm) set forth in Table 1, below.

Control samples were produced by mechanically crimping the webs together to form a tissue product. Mechanically bonded tissue products were formed passing two superposed plies through the nip of a crimp roll arrangement. The crimp roll arrangement included hardened-steel crimp rolls and a smooth, hardened-steel anvil roll. Each crimp roll measured about ⅛ inches in width and about 6 inches in diameter. The crimp rolls (i.e., pattern rolls) had protruding members configured in a discontinuous pattern aligned on an axis parallel to the cross-machine direction of the tissue plies. Each protruding member had a total surface area which comes in contact with the tissue plies of about 0.75 mm². Conventional air-pressure loading means were used to apply a pressure load against the crimp roll of about 100 pounds of reactive force. A total load was calculated from the pressure load and the combined weights of the crimp roll and crimp roll mount. The total pressure load was calculated to be about 886 pounds per linear inch of contact across the areas of localized surface contact (i.e., width of the plies). After crimping, the laminate was cut to a width of approximately 8.4 inches and then wound onto a roll.

Adhesively bonded tissue products were formed by spraying two strips of adhesive to a first tissue web, which was combined with a second tissue web (which did not contain adhesive) and combining the webs. Adhesive (see Table 1 below for details, all adhesives are commercially available from H. B. Fuller, St. Paul, Minn.) was applied to one of the webs by a pressurized head unit having two nozzles, which was centered on the midpoint of the web and between six and ten inches away (see Table 1 for details). The two spray nozzles applied two strips of adhesive. For Samples 1, 2 and 3 adhesive strips were applied inward of the first and second edges resulting in an adhesive free area between the adhesive strips and the edges which measured about 0.5 cm in width. For Sample 4 the adhesive strips were applied immediately adjacent to the edges of the web. The strip width varied between about 1.5 to about 2.0 cm, depending on the distance between the spray nozzle and the web, the adhesive spray rate (measured as liters per hour, L/hr) and the spray pressure (measured in pounds per square inch, psi). The adhesively treated web was then brought into facing relation with the second web and passed through a nip created by two opposing rolls. The nip pressure was 30 pounds per linear inch (pli). The physical properties of the resulting laminate are detailed below in Table 2.

TABLE 1

| | | | | Adhesive | |
|---|---|---|---|---|---|
| | | Adhesive | Distance | Spray Rate | Web Speed |
| Sample | Adhesive | (psi) | (inch) | (L/hr) | (fpm) |
| 1 | HB Fuller | 16 | 10 | 0.68 | 2000 |
| | TT5000B | | | | |
| 2 | HB Fuller | 18 | 10 | 0.80 | 2000 |
| | TT5000B | | | | |
| 3 | HB Fuller | 18 | 6 | 0.80 | 2000 |
| | TT5000B | | | | |
| 4 | HB Fuller | 18 | 6 | 0.75 | 1500 |
| | TT5000B | | | | |

TABLE 2

| | Basis Weight | GMT | Ply Attachment | GM Slope | Stiffness |
|---|---|---|---|---|---|
| Sample | (gsm) | (g/3″) | Strength (g) | (kgf/3″) | Index |
| Control | 26.8 | 844 | 24.0 | 12.28 | 14.5 |
| 1 | 25.5 | 798 | 16.1 | 15.38 | 19.3 |
| 2 | 26.8 | 795 | 32.7 | 13.12 | 16.5 |
| 3 | 27.0 | 883 | 32.0 | 12.90 | 14.6 |
| 4 | 26.5 | 717 | 111.0 | 12.54 | 17.5 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

We claim:

1. An adhesively bonded multi-ply tissue laminate comprising a first tissue ply, a second tissue ply and an adhesive disposed between the first and second plies, wherein adhesive is disposed to provide at least two discrete bonded areas that extend the length of the plies.

2. The tissue laminate of claim 1 wherein the total bonded surface area is from about 5 to about 15 percent of the total surface area of the laminate.

3. The tissue laminate of claim 1 having a ply attachment strength of at least about 15 grams.

4. The tissue laminate of claim 1 wherein the adhesive is disposed as two discrete continuous strips having a width from about 0.5 to about 2.5 centimeters.

5. The tissue laminate of claim 1 wherein the individual plies have basis weights ranging from about 10 to about 30 grams per square meter.

6. The fibrous laminate of claim 1 wherein the total amount of adhesive is from about 20 to about 200 mg per square meter of bonded area.

7. The fibrous laminate of claim 1 wherein the first and second plies are unembossed.

8. An adhesively bonded multi-ply tissue laminate having first and second edges, the laminate comprising a first tissue ply, a second tissue ply and first and second longitudinally orientated adhesive strips disposed between the first and second plies.

9. The tissue laminate of claim 8 wherein the first and second adhesive strips are continuous.

10. The tissue laminate of claim 8 wherein there is an area of tissue between the first and second adhesive strips and the first and second edges that is substantially free of adhesive.

11. The tissue laminate of claim 8 wherein the first and second adhesive strips cover from about 5 to about 15 percent of the total surface area of the laminate.

12. The tissue laminate of claim 8 having a ply attachment strength of at least about 15 grams.

13. The tissue laminate of claim 8 wherein the first and second adhesive strips have a width from about 0.5 to about 2.5 centimeters.

14. The tissue laminate of claim 8 wherein the individual plies have a basis weight ranging from about 10 to about 30 grams per square meter.

15. The fibrous laminate of claim 8 wherein the total amount of adhesive is from about 20 to about 200 mg per square meter of laminate surface area.

16. The fibrous laminate of claim 8 wherein the first and second plies are unembossed.

17. An adhesively bonded multi-ply tissue laminate comprising a first unembossed tissue ply, a second unembossed tissue ply and two discrete longitudinally orientated continuous strips of adhesive disposed between the first and second plies, wherein the tissue laminate has a ply attachment strength of at least about 15 grams, a Stiffness Index of less than about 20 and a geometric mean tensile of at least about 500 g/3″.

18. The tissue laminate of claim 17 wherein the laminate is substantially rectangular, having a length (L) that is greater than its width (W) and a longitudinally orientated midpoint that is substantially free of adhesive.

19. The fibrous laminate of claim 17 wherein the total amount of adhesive is from about 20 to about 200 mg per square meter of adhesive area.

20. The tissue laminate of claim 17 wherein the two discrete adhesive strips each have a width from about 0.5 to about 2.5 centimeters.
